(19) United States
(12) Patent Application Publication
(10) Pub. No.: US 2009/0128036 A1
(43) Pub. Date: May 21, 2009

(54) PLASMA DISPLAY PANEL

(76) Inventor: Jung-Min Kim, Suwon-si (KR)

Correspondence Address: CHRISTIE, PARKER & HALE, LLP, PO BOX 7068, PASADENA, CA, 91109-7068, US

(21) Appl. No.: 12/269,312

(22) Filed: Nov. 12, 2008

(30) Foreign Application Priority Data
Nov. 15, 2007 (KR) 10-2007-0116761

(51) Int. Cl. H01J 17/49

(52) U.S. Cl. 313/586

(57) ABSTRACT

A plasma display panel (PDP) having high driving efficiency obtained by improving an address voltage margin; having high image quality obtained by removing noisy brightness such as discharge light generated when an address discharge occurs or background light; and suitable for an image display with high efficiency and high resolution. The PDP includes a plurality of first barrier ribs between a first substrate and a second substrate, the first barrier ribs defining a plurality of unit cells; and a plurality of second barrier ribs dividing each of the unit cells into a main discharge space and an auxiliary discharge space. A row of the auxiliary discharge spaces is adjacent and between two rows of the main discharge spaces. The PDP also includes a phosphor layer in the main discharge spaces; and a plurality of grooves in the second barrier ribs between the main discharge spaces and the auxiliary discharge spaces.

### CROSS-REFERENCE TO RELATED PATENT APPLICATION

This application claims priority to and the benefit of Korean Patent Application No. 10-2007-0116761, filed on Nov. 15, 2007, in the Korean Intellectual Property Office, the disclosure of which is incorporated herein in its entirety by reference.

### BACKGROUND OF THE INVENTION

1. Field of the Invention

The present invention relates to a plasma display panel (PDP), and more particularly, to addressing operations of a PDP.

2. Description of the Related Art

In a PDP, a plurality of discharge cells arranged as a matrix are interposed between a front substrate and a rear substrate that face each other. The front substrate has disposed thereon scan electrodes and sustain electrodes for generating a discharge, and the rear substrate has disposed thereon a plurality of address electrodes. The front substrate and the rear substrate are bonded so as to be sealed together, a predetermined discharge gas is injected between the front and rear substrates, and phosphors coated in the discharge cells are excited by generating predetermined discharge pulses between discharge electrodes (that is, the scan and sustain electrodes) so as to generate visible light, thereby realizing a desired image.

In order to realize gradation (e.g., colors, gray levels, or brightness) of an image, PDPs having such a structure perform a time-division operation by dividing one frame into several sub-fields having different light emission levels, in which each of the sub-fields is divided into a reset period to uniformly cause a discharge, an address period to select discharge cells, and a sustain period to realize gradation of an image according to the number of discharges. In the address period, auxiliary discharges are generated between the address electrodes and the scan electrodes, and wall voltages are formed in the selected discharge cells so as to form a suitable environment for sustain discharges.

In general, the address period requires a higher voltage than that required for a sustain discharge. Therefore, a low input voltage, that is, a low address voltage, to perform a smooth addressing operation and ensuring a high voltage margin is essential to improving the operation efficiency and discharge stability of a PDP. In addition, as PDPs are developed to full-HD resolution levels, the number of discharge cells required substantially increases and thus the number of address electrodes allotted to the discharge cells also increases. Therefore, a circuit unit should be designed to cope with high consumption power. Due to these reasons, high operation efficiency is required to operate with low electric power. In addition, a high xenon (Xe) display using a high partial pressure of Xe in the discharge gas injected inside the PDP has high luminous efficiency but requires a relatively high address voltage for initiating a discharge. Thus, a sufficient address voltage margin should be obtained to realize a highly efficient display.

### SUMMARY OF THE INVENTION

Embodiments of the present invention provide a plasma display panel (PDP) having high driving efficiency obtained by improving an address voltage margin.

Embodiments of the present invention also provide a PDP having high quality and high contrast obtained by removing noisy brightness, such as discharge light generated when an address discharge occurs or background light.

Embodiments of the present invention also provide a PDP suitable for an image display with high efficiency and high resolution.

According to an embodiment of the present invention, a plasma display panel (PDP) includes: a first substrate; a second substrate facing the first substrate; a plurality of first barrier ribs between the first and second substrates and defining a plurality of cells; a plurality of second barrier ribs, each dividing a corresponding one of the cells into a main discharge space and an auxiliary discharge space that are adjacent to each other; a scan electrode and a sustain electrode, the scan electrode and the sustain electrode configured to generate a display discharge in the cells; address electrodes configured to generate an address discharge together with the scan electrode, the address electrodes extending in a direction perpendicular to an extending direction of the scan electrode; phosphor layers in the main discharge spaces; and a plurality of grooves in the second barrier ribs, each of the grooves between a corresponding one of the main discharge spaces and a corresponding one of the auxiliary discharge spaces, wherein a row of the auxiliary discharge spaces is between and adjacent to two rows of the main discharge spaces.

The plurality of cells may form a delta structure.

The delta structure may include sub-pixels arranged in a triangular shape and constituting one pixel.

A width of the main discharge space may be larger than a width of the auxiliary discharge space.

The main discharge space and the auxiliary discharge space may be connected to each other, and the grooves may be formed at least a top surface of the second barrier ribs.

One of the two rows of the main discharge spaces may include upper main discharge spaces and the other of the two rows of the main discharge spaces may include lower main discharge spaces. The grooves may be formed in the second barrier ribs in an alternating one-to-one correspondence with the upper and lower main discharge spaces so that one of the auxiliary discharge spaces is connected with one of the upper or lower main discharge spaces.

The second barrier ribs may face the scan electrode with a discharge gap therebetween.

At least a portion of the second barrier ribs may have a height smaller than the height of the first barrier ribs.

The second barrier ribs may be closer to the scan electrode than to the sustain electrode.

The phosphor layers may not be located in the auxiliary discharge spaces.

The scan electrode and the sustain electrode may include a pair of sustain electrodes and a pair of scan electrodes between the sustain electrodes.

According to another embodiment of the present invention, a PDP includes: a front substrate and rear substrate that face each other; a plurality of first barrier ribs that are disposed between the front substrate and the rear substrate to define a plurality of cells; a scan electrode and a sustain electrode configured to generate a display discharge in the cells; a plurality of second barrier ribs, each dividing a corresponding one of the cells into a main discharge space and an auxiliary discharge space that are adjacent to each other, the plurality of second barrier ribs having a plurality of grooves formed therein; address electrodes configured to generate an address discharge together with the scan electrode, the address electrodes extending in a direction perpendicular to an extending direction of the scan electrode; and phosphor layers respectively located in the main discharge spaces, wherein the sustain electrode includes two row sustain electrodes and the scan electrode includes one row scan electrode between the two row sustain electrodes.

The plurality of cells may form a delta structure.

The width of the main discharge space may be larger than the width of the auxiliary discharge space.

The main discharge spaces may be in two rows and the auxiliary discharge spaces may be in one row between the two rows of the main discharge spaces.

One of the two rows of the main discharge spaces may include upper main discharge spaces and the other of the two rows of the main discharge spaces may include lower main discharge spaces. The grooves may be in the second barrier ribs in an alternating one-to-one correspondence with the upper and lower main discharge spaces so that one of the auxiliary discharge spaces is connected with one of the upper or lower main discharge spaces.

The second barrier ribs may face the scan electrode with a discharge gap therebetween.

At least a portion of the second barrier ribs may have a height smaller than a height of the first barrier ribs.

The second barrier ribs may be closer to the scan electrode than to the sustain electrode.

The phosphor layers may not be in the auxiliary discharge spaces.

Each of the two row sustain electrodes may generate a display discharge together with the one row scan electrode.

The scan electrode and the sustain electrode may include a pair of sustain electrodes and a scan electrode between the sustain electrodes.

According to yet another embodiment of the present invention, a PDP includes: a first substrate; a second substrate facing the first substrate; a plurality of barrier ribs between the first substrate and the second substrate, the plurality of barrier ribs defining a plurality of cells; a scan electrode and a sustain electrode configured to generate a display discharge in the cells; address electrodes configured to generate an address discharge together with the scan electrode, the address electrodes extending in a direction perpendicular to an extending direction of the scan electrode; and phosphor layers located in the main discharge spaces, wherein the barrier ribs include: first barrier ribs defining a plurality of first main discharge cells in a first row and a plurality of second main discharge cells in a second row, each of the first main discharge cells being offset from each of the second main discharge cells in a column direction, and second barrier ribs defining a plurality of auxiliary discharge cells in a third row between the first row and the second row, wherein grooves are formed in the first barrier ribs, each of the grooves located between one of the auxiliary discharge cells and a corresponding one of the first main discharge cells or a corresponding one of the second main discharge cells, in an alternating arrangement along the third row.

The plurality of cells may form a delta structure.

The delta structure may include sub-pixels arranged in a triangular shape and constituting one pixel.

### BRIEF DESCRIPTION OF THE DRAWINGS

The above and other features and aspects of the present invention will become more apparent by describing in detail exemplary embodiments thereof with reference to the attached drawings in which:

FIG. 1 is a partial exploded perspective view of a plasma display panel (PDP) according to a first embodiment of the present invention;

FIG. 2 is a vertical sectional view taken along the line II-II of FIG. 1;

FIG. 3 is a plan view of the PDP of FIG. 1;

FIG. 4 is a perspective view illustrating the arrangement of some of the components of the PDP of FIG. 1;

FIG. 5 is a partial exploded perspective view of a PDP according to a second embodiment of the present invention;

FIG. 6 is a vertical sectional view taken along the line VI-VI of FIG. 5; and

FIG. 7 is a perspective view illustrating the arrangement of some of the components of the PDP of FIG. 5.

### DETAILED DESCRIPTION OF EMBODIMENTS

Embodiments of the present invention will now be described more fully with reference to the accompanying drawings, in which exemplary embodiments of the invention are shown.

### First Embodiment

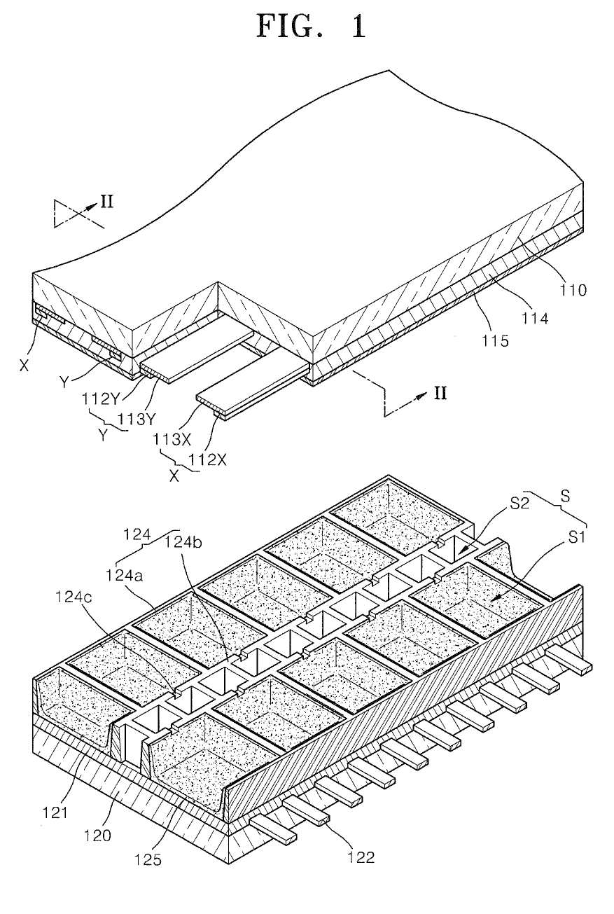

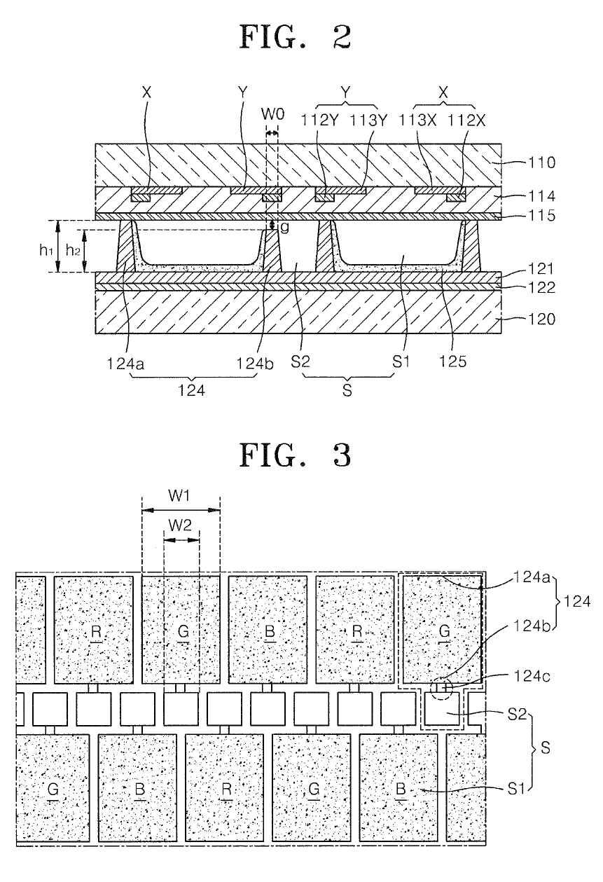

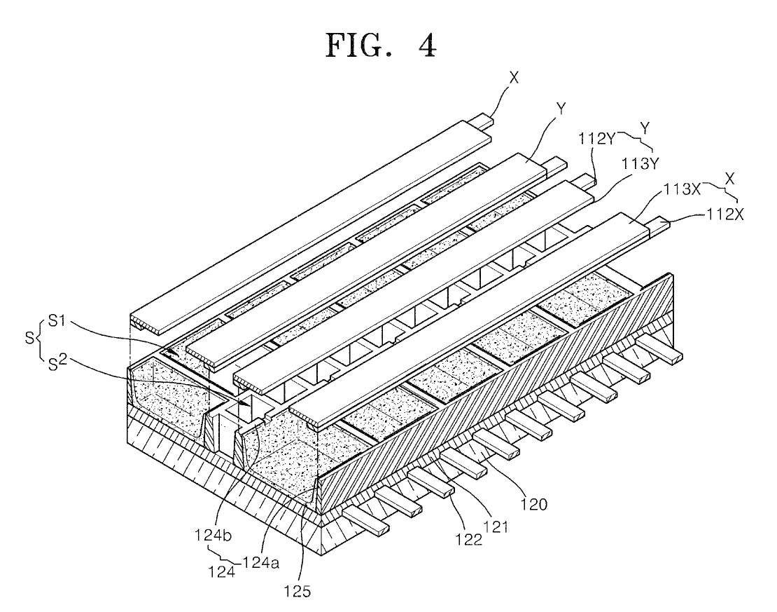

FIG. 1 is a partial exploded perspective view of a PDP according to a first embodiment of the present invention, FIG. 2 is a vertical sectional view taken along the line II-II in FIG. 1, FIG. 3 is a plan view of the PDP of FIG. 1, and FIG. 4 is a perspective view illustrating the arrangement of some of the components of the PDP of FIG. 1.

The PDP of FIG. 1 includes a front substrate 110, a rear substrate 120 which is separated from and faces the front substrate 110, and a plurality of barrier ribs 124 for partitioning a space between the front substrate 110 and the rear substrate 120 into a plurality of unit cells S.

The unit cell S is a minimum (or smallest) light-emitting unit in which a pair of sustain electrodes X and Y generate a display discharge and in which an address electrode 122 extends to cross the pair of sustain electrodes X and Y. The unit cell S is defined by the barrier rib 124, thereby realizing a display (e.g., a predetermined display). Each unit cell S constitutes an independent light emitting area.

The pair of sustain electrodes X and Y includes a sustain electrode X and a scan electrode Y which generate a display discharge in pairs. The sustain electrodes X and scan electrodes Y respectively include bus electrodes 112X and 112Y, which form power lines for supplying driving power, and transparent electrodes 113X and 113Y, which are formed of an optically transparent material, electrically contacting the bus electrodes 112X and 112Y and extending along a width of each unit cell S.

In addition, in the first embodiment, the pair of sustain electrodes X and Y is covered by a dielectric layer 114 such that the pair of sustain electrodes X and Y is not directly exposed to a discharge environment, and thus is protected from direct collisions with charged particles participating in a discharge. The dielectric layer 114 may be covered and protected by a protective layer 115 formed of, for example, an MgO thin film. The protective layer 115 may induce emission of secondary electrons and thereby facilitate a discharge.

The address electrodes 122 are disposed on the rear substrate 120. The address electrodes 122 perform an address discharge together with the scan electrode Y. In each unit cell S, the address electrode 122 is substantially perpendicular to the scan electrode Y. The address discharges are auxiliary discharges that support display discharges by accumulating priming particles in each unit cell S before display discharges occur. A discharge voltage applied between the scan electrode Y and the address electrode 122 can be focused in an area that is in the vicinity of a discharge gap g through the dielectric layer 114 covering the scan electrode Y and the barrier ribs 124 on the address electrode 122. Therefore, an initial discharge may occur through the discharge gap g which provides the shortest discharge pathway.

In one embodiment, the address electrodes 122 are covered by a dielectric layer 121 on the rear substrate 120, and the barrier ribs 124 are formed on a surface of the dielectric layer 121.

The barrier ribs 124 define a plurality of main discharge spaces S1 and a plurality of auxiliary discharge spaces S2 that are adjacent to the corresponding main discharge spaces S1. The barrier ribs 124, the main discharge spaces S1, and the auxiliary discharge spaces S2 are between the front substrate 110 and the rear substrate 120. In one embodiment, each of the barrier ribs 124 includes a first barrier rib 124a and a second barrier rib 124b. Dotted lines at the right side of FIG. 3 represent the first barrier rib 124a, as well as a second barrier rib 124b that divides each unit cell S into a main discharge space S1 and an auxiliary discharge space S2. The first barrier ribs 124a have a first height h1, and the second barrier ribs 124b have a groove 124c configured so that a region of each of the second barrier ribs 124b in which the groove 124c is formed has a second height h2. Division of a discharge space into the main discharge space S1 and the auxiliary discharge space S2 may be made according to their discharge volumes. However, functions of the main discharge space S1 and the auxiliary discharge space S2 may be similar. For example, a display discharge can occur in the form of a long gap in the auxiliary discharge space S2, as well as in the main discharge space S1.

In the first embodiment, the first barrier ribs 124a have the first height h1 so that unit cells S are substantially sealed to reduce optical and electrical cross-talk between adjacent unit cells S. The term “seal” does not mean that the unit cell S is hermetically sealed, and a minute-sized gap may exist on the first barrier rib 124a.

A large portion of the second barrier ribs 124b have a height substantially equal to the height h1 of the first barrier ribs 124a. However, the grooves 124c are formed in at least one portion of a top surface of the second barrier ribs 124b so that the regions of the second barrier ribs 124b in which the grooves 124c are formed have the second height h2 that is less than the height h1 of the first barrier ribs 124a. As a result, the grooves 124c form a discharge gap g and provide a flow pathway for priming particles formed as a result of the address discharge, thereby allowing priming particles formed in the auxiliary discharge space S2 to flow into the main discharge space S1. Thus, the priming particles formed in the auxiliary discharge space S2 as a result of the address discharge are easily diffused to the main discharge space S1 along the pathway formed by the groove 124c of the second barrier ribs 124b so as to participate in the display discharge.

In addition, the address voltage applied between the scan electrode Y and the address electrode 122 may be more effective in the auxiliary discharge space S2 than in the main discharge space S1 where a phosphor layer 125 additionally screens the address electrode 122. In this regard, the auxiliary discharge space S2 may be formed to have a volume such that a sufficient amount of discharge gas can be contained therein so as to supply sufficient priming particles through the address discharge. For example, in each unit cell S, the location of the second barrier rib 124b can be adjusted to increase or decrease the volume of the auxiliary discharge space S2.

In addition, the address discharge can be initiated along the discharge gap g via a bottom surface of the groove 124c of the second barrier rib 124b facing the scan electrode Y as a facing discharge surface. Herein, the scan electrode Y and the second barrier rib 124b may be aligned with respect to each other. In particular, the scan electrode Y and the second barrier rib 124b may partially overlap each other by a width WO.

The address discharge usually occurs in the auxiliary discharge space S2 and provides priming particles for a display discharge. That is, the address discharge itself is not related to a display emission. When a discharge light is generated during the address discharge and leaks outside together with a display emission, noise brightness appears as a haze adjacent to an emission pixel, thereby reducing the clarity of a display. To prevent or reduce this problem, a discharge light generated in the auxiliary discharge space S2 can be blocked by including black stripes on the auxiliary discharge space S2. However, such black stripes are not required since the bus electrode 112Y, which constitutes the scan electrode Y is often formed of a metallic conductive material allowing the bus electrode 112Y itself to block light.

According to the first embodiment of the present invention, the main discharge space S1 for a display discharge and the auxiliary discharge space S2 for an address discharge are separated from each other and a device for blocking the discharge light may be included. For example, a black stripe can be selectively disposed. By contrast, in terms of conventional technology, a display discharge and an address discharge occur at the same space, and thus, a discharge light cannot be blocked and the display quality is reduced. Specifically, a visible light generated by a phosphor activated by the address discharge forms a background light and a contrast effect may be degraded. However, according to the first embodiment of the present invention, the phosphor is structurally isolated from the auxiliary discharge space S2 in which the address discharge primarily occurs. Therefore, the background light generated when the phosphor emits light during the address discharge can be substantially removed, and a high quality display having high contrast can be realized.

The phosphor (or “fluorescence”) layer 125 is formed on inner walls of the main discharge space S1. For example, the fluorescence layer 125 may be formed on side walls of the first and second barrier ribs 124a and 124b contacting the main discharge space S1 and on a portion of the dielectric layer 121 between the first and second barrier ribs 124a and 124b. The fluorescence layer 125 may react with ultraviolet rays generated as a result of the display discharge to form visible light of various colors. For example, red (R), green (G), and blue (B) phosphors may be coated on the inside of the main discharge space S1, thereby defining the main discharge space S1 or the unit cell S as a R sub-pixel, a G sub-pixel, or a B sub-pixel.

Alternatively, the fluorescence layer 125 may not be formed in the auxiliary discharge space S2. Different phosphors of different materials have various electrical properties and can greatly affect a discharge environment. For example, a zinc silicate-based G phosphor, such as Zn₂SiO₄:Mn is inclined to have a negative (−) surface potential. On the other hand, R and B phosphors, such as Y(V,P)O₄:Eu or BAM:Eu, are inclined to have positive (+) surface potential. Therefore, to form a uniform discharge environment by preventing phosphor discharge interference, the phosphors should be isolated from the pathway of the address discharge. As such, in the present embodiment, the phosphor is not coated in the auxiliary discharge space S2.

In a conventional PDP, phosphor is directly exposed to an address discharge. As a result, even when the same address voltage is applied, a voltage inside the discharge space may vary according to the electrical properties of the phosphor. That is, a G phosphor which tends to be negatively (−) charged reduces the address voltage, and on the other hand, R and B phosphors which tend to be positively (+) charged increase the address voltage. Therefore, although the same address voltage is applied to G, R, and B phosphors, voltages in discharge spaces having G, R, and B phosphors may differ from each other, and thus, an address voltage margin is decreased.

When the main discharge space S1 in which a display discharge primarily occurs is separated from the auxiliary discharge space S2 in which an address discharge primarily occurs and phosphor is not formed in the auxiliary discharge space S2, an address voltage applied from the outside can be substantially uniformly provided to all of the auxiliary discharge spaces S2 according to unique electrical properties of phosphor, and thus, the address voltage margin can be significantly increased. In addition, compared to conventional techniques, the same pre-discharge effect can be obtained using only a low address voltage, and when the same address voltage is applied, more priming particles can be accumulated and the subsequent display discharge can have a high discharge intensity.

A discharge gas as a source gas for ultraviolet rays is provided to the unit cell S including the main discharge space S1 and the auxiliary discharge space S2. The discharge gas may be a multi-component gas (i.e., mixed gas) including Xe, Kr, He, and Ne in a suitable volume ratio (e.g., a predetermined volume ratio). The discharge gas is capable of emitting ultraviolet rays through discharge excitation. It is well known in the art that when the partial pressure of Xe in the discharge gas is high, that is, a high-Xe discharge gas is used, high emission efficiency can be obtained. However, the high-Xe discharge gas cannot be practically applied or has limited applications because it requires a large amount of operation power due to high initial discharge voltage, as well as a circuit adapted for high power. However, because of the capability of a PDP according to the first embodiment to provide a high address voltage, sufficient priming particles can be obtained to ignite a discharge. Therefore, a high-Xe PDP can be realized, and emission efficiency can be significantly improved.

In a PDP according to the first embodiment, the unit cells S may have a delta structure having a triangular pattern, and each of the unit cells S may be divided into the main discharge space S1 and the auxiliary discharge space S2 by the second barrier rib 124b.

PDPs, including conventional PDPs, may be classified as a stripe-type PDP (or an inline-type PDP) or a delta-type PDP according to an arrangement pattern of a unit pixel. A stripe-type PDP has a structure in which discharge cells, where a gas discharge occurs, are defined by barrier ribs and are arranged in a stripe pattern. By contrast, a delta-type PDP has a structure in which the discharge cells are arranged in a triangle pattern. A conventional stripe-type PDP has low space utilization, and thus, when a stripe-type PDP has ultra-high resolution as it is upgraded to a full-HD level, the main discharge space becomes smaller, and luminance and efficiency of the PDP are degraded. In addition, even with a delta-type PDP, which may address the problems described above and increase the main discharge space, it is not easy to reduce an input voltage (address voltage) for smooth addressing and obtain a voltage margin.

To address the problems described above, in a PDP according to the first embodiment, the unit cells S are formed in a delta structure to expand the main discharge space S1, and at the same time, each of the unit cells S is divided into the main discharge space S1 and the auxiliary discharge space S2 to decrease the address voltage and obtain the voltage margin.

According to the first embodiment, the main discharge spaces S1 are formed in two rows facing each other, and the auxiliary discharge spaces S2 are formed in one row between the two rows of the main discharge spaces S1. With reference to FIG. 3, the main discharge spaces S1 are arranged in two rows in a longitudinal direction, and the auxiliary discharge spaces S2 are formed in one row between the two rows of the main discharge spaces S1. In addition, the main discharge spaces S1 are arranged in the two rows in an alternating manner. That is, one of the two rows of the main discharge spaces includes upper main discharge spaces, and the other of the two rows of the main discharge spaces includes lower main discharge spaces. The auxiliary discharge spaces S2 are formed between upper and lower main discharge spaces S1 in an alternating arrangement. Therefore, a width W1 of the main discharge space S1 is larger than a width W2 of the auxiliary discharge space S2.

In the auxiliary discharge spaces S2, the grooves 124c are formed in the second barrier ribs 124b in an alternating one-to-one correspondence with the upper and lower main discharge spaces S1 so that each one of the auxiliary discharge spaces S2 is connected with one of the upper or lower main discharge spaces S1.

In addition, with further reference to FIG. 3, R, G, and B sub-pixels are alternately disposed in the upper and lower main discharge spaces S1, respectively, and thus the R, G, and B sub-pixels form a delta structure with a triangular shape.

As described above, a PDP according to the first embodiment of the present invention has a structure in which the arrangement of the R, G, and B sub-pixels forms a delta structure with a triangular shape. Thus, when the R, G, and B sub-pixels form one pixel, the width of the unit pixel including the R, G, and B sub-pixels can be decreased in a row direction. Therefore, compared to the PDP having a structure in which unit pixels are formed in a stripe form, the PDP of the present invention has high resolution, and also, a rate of occupying a non-emitting region in a screen is decreased so that a display with high luminance can be realized.

### Second Embodiment

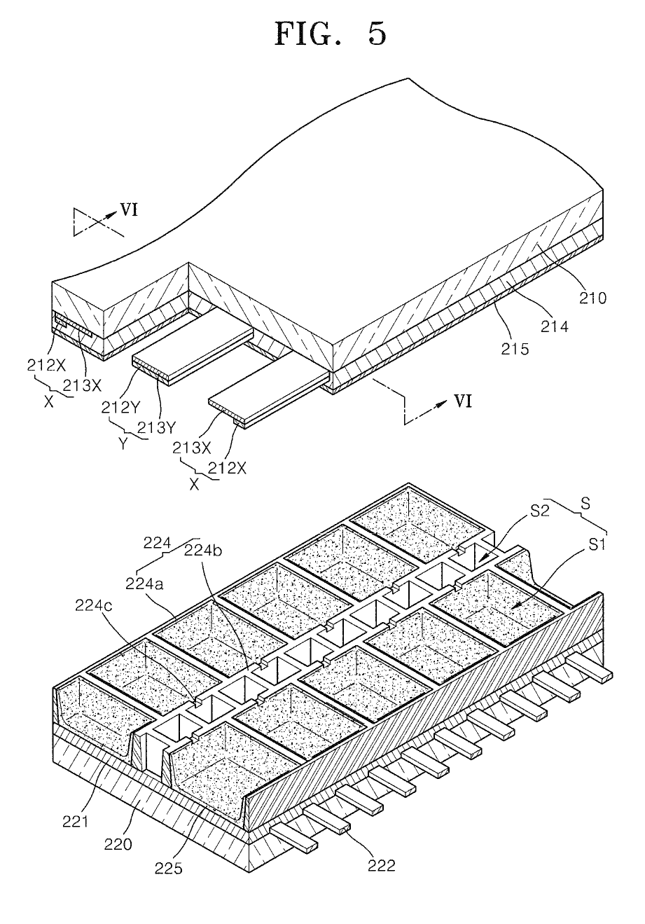

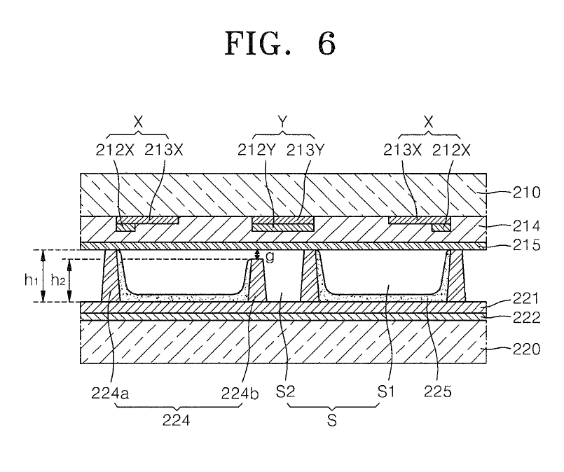

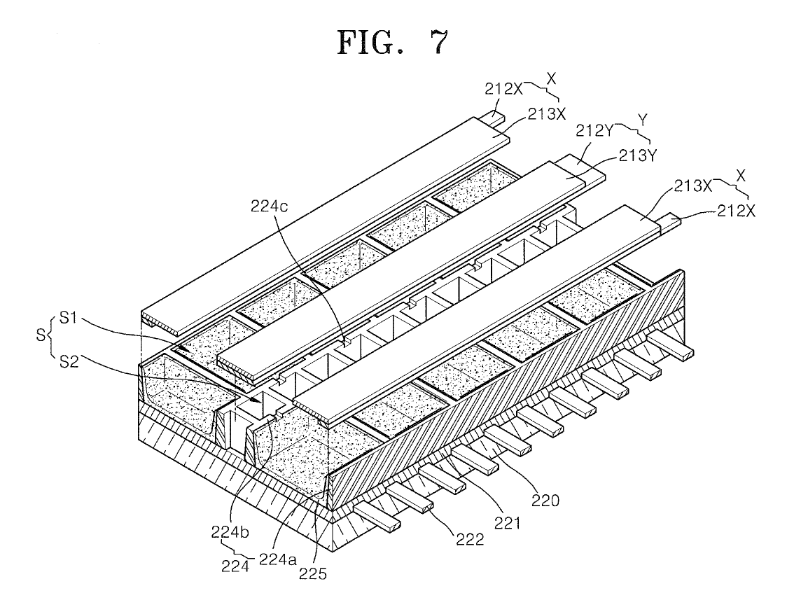

FIG. 5 is a partial exploded perspective view of a PDP according to a second embodiment of the present invention, FIG. 6 is a vertical sectional view taken along the line VI-VI of FIG. 5, and FIG. 7 is a perspective view illustrating the arrangement of some of the components of the PDP of FIG. 5.

With reference to FIGS. 5-7, a PDP according to the second embodiment includes a plurality of first barrier ribs 224a between a front substrate 210 and a rear substrate 220 that face each other to define a plurality of unit cells S. The PDP further includes a plurality of second barrier ribs 224b between the front substrate 210 and the rear substrate 220, the second barrier ribs 224b dividing each unit cell S into a main discharge space S1 and an auxiliary discharge space S2. More specifically, a plurality of barrier ribs 224 includes the first barrier ribs 224a having a first height h1 and dividing a space between the front substrate 210 and the rear substrate 220 into the plurality of unit cells S. The barrier ribs 224 also include the second barrier ribs 224b dividing each of the unit cells S into a main discharge space S1, which may include a phosphor layer 225, and an auxiliary discharge space S2. Grooves 224c are formed in the second barrier ribs 224b such that regions of the second barrier ribs 224b where the grooves 224c are formed have a second height h2.

Similar to the PDP of the first embodiment described above, the main discharge spaces S1, according to the second embodiment, are alternately arranged in two rows facing each other (including upper main discharge spaces in one row and lower main discharge spaces in the other row), and the auxiliary discharge spaces S2 are formed in one row between the two rows of the main discharge spaces S1. Each of the auxiliary discharge spaces S2 corresponds to one of the main discharge spaces S1, each of the alternating auxiliary discharge spaces S1 corresponding to a discharge space S1 from one or the other of the two rows, in an alternating manner. As a result of this alternating arrangement, a width W1 of the main discharge space S1 is larger than a width W2 of the auxiliary discharge space S2.

The grooves 224c are alternately formed in the second barrier ribs 224b in an alternating one-to-one correspondence with the upper and lower main discharge spaces S1 so that one of the auxiliary discharge spaces S2 is connected with one of the upper or lower main discharge spaces S1. In addition, R, G, and B sub-pixels are alternately disposed in the upper and lower main discharge spaces S1, respectively, and thus the R, G, and B sub-pixels form a delta structure with a triangular shape.

In addition, in each unit cell S defined by the first barrier rib 224a, a pair of a scan electrode Y and a sustain electrode X are configured to generate a display discharge. An address electrode 222, configured to generate an address discharge together with the scan electrode Y, extends in a direction perpendicular to an extension direction of the scan electrode Y. Each pair of the sustain electrode X and the scan electrode Y includes bus electrodes 212X and 212Y and transparent electrodes 213X and 213Y, and is covered by a dielectric layer 214. The dielectric layer 214 may be covered and protected by a protective layer 215 formed of, for example, an MgO thin film. In addition, the address electrodes 222 are on the rear substrate 220, and a dielectric layer 221 covers the address electrodes 222. The second barrier rib 224b is in a region corresponding to the scan electrode Y. The second barrier rib 224b has a discharge gap g and provides a facing discharge surface that faces the scan electrode Y.

According to the second embodiment, the sustain electrode X includes two row sustain electrodes X and the scan electrode Y includes one row scan electrode Y between the two row sustain electrodes X.

According to the second embodiment, the one row of the auxiliary discharge spaces S2 is between the two rows of the main discharge spaces S1. Thus, the sustain electrode X may correspond to each of the two rows of the main discharge spaces S1. In addition, the one row scan electrode Y may correspond to the one row of the auxiliary discharge spaces S2. Therefore, each of the two row sustain electrodes X can generate a display discharge together with the one row scan electrode Y that operates as a common electrode. This way, the panel capacitance of the PDP is decreased, resulting in the reduction of reactive power.

A PDP according to embodiments of the present invention includes a plurality of unit cells having a delta structure, providing a reduced address voltage. Also, by preventing discharge interference with phosphor that is disposed in a conventional address discharge pathway, an address voltage margin can be increased. Accordingly, a display with high efficiency can be realized using a high-Xe discharge gas, and a display having high resolution corresponding to a full-HD level can be achieved with reduced power consumption.

In addition, according to embodiments of the present invention, by removing noise brightness that appears as haze around a display emission and degrades clarity of images, such as a discharge light generated when an address discharge occurs or background light, high-quality images having high contrast can be provided.

While the present invention has been particularly shown and described with reference to exemplary embodiments thereof, it will be understood by those of ordinary skill in the art that various changes in form and details may be made therein without departing from the spirit and scope of the present invention as defined by the following claims and their equivalents.

What is claimed is:

1. A plasma display panel (PDP) comprising:
a first substrate;
a second substrate facing the first substrate;
a plurality of first barrier ribs between the first and second substrates and defining a plurality of cells;
a plurality of second barrier ribs, each dividing a corresponding one of the cells into a main discharge space and an auxiliary discharge space that are adjacent to each other;
a scan electrode and a sustain electrode, the scan electrode and the sustain electrode configured to generate a display discharge in the cells;
address electrodes configured to generate an address discharge together with the scan electrode, the address electrodes extending in a direction perpendicular to an extending direction of the scan electrode;
phosphor layers in the main discharge spaces; and
a plurality of grooves in the second barrier ribs, each of the grooves between a corresponding one of the main discharge spaces and a corresponding one of the auxiliary discharge spaces,
wherein a row of the auxiliary discharge spaces is between and adjacent to two rows of the main discharge spaces.

2. The PDP of claim 1, wherein the plurality of cells forms a delta structure.

3. The PDP of claim 2, wherein the delta structure comprises sub-pixels arranged in a triangular shape and constituting one pixel.

4. The PDP of claim 1, wherein a width of the main discharge space is larger than a width of the auxiliary discharge space.

5. The PDP of claim 1, wherein the main discharge space and the auxiliary discharge space are connected to each other, and the grooves are formed at least a top surface of the second barrier ribs.

6. The PDP of claim 1, wherein one of the two rows of the main discharge spaces comprises upper main discharge spaces and the other of the two rows of the main discharge spaces comprises lower main discharge spaces, and wherein the grooves are formed in the second barrier ribs in an alternating one-to-one correspondence with the upper and lower main discharge spaces so that one of the auxiliary discharge spaces is connected with one of the upper or lower main discharge spaces.

7. The PDP of claim 1, wherein the second barrier ribs face the scan electrode with a discharge gap therebetween.

8. The PDP of claim 1, wherein at least a portion of the second barrier ribs has a height smaller than the height of the first barrier ribs.

9. The PDP of claim 1, wherein the second barrier ribs are closer to the scan electrode than to the sustain electrode.

10. The PDP of claim 1, wherein the phosphor layers are not located in the auxiliary discharge spaces.

11. The PDP of claim 1, wherein the scan electrode and the sustain electrode comprise a pair of sustain electrodes and a pair of scan electrodes between the sustain electrodes.

12. A plasma display panel (PDP) comprising:
a first substrate;
a second substrate facing the first substrate;
a plurality of first barrier ribs between the first substrate and the second substrate, the plurality of first barrier ribs defining a plurality of cells;
a scan electrode and a sustain electrode configured to generate a display discharge in the cells;
a plurality of second barrier ribs, each dividing a corresponding one of the cells into a main discharge space and an auxiliary discharge space that are adjacent to each other, the second barrier ribs having a plurality of grooves formed therein;
address electrodes configured to generate an address discharge together with the scan electrode, the address electrodes extending in a direction perpendicular to an extending direction of the scan electrode; and
phosphor layers respectively located in the main discharge spaces,
wherein the sustain electrode comprises two row sustain electrodes and the scan electrode comprises one row scan electrode between the two row sustain electrodes.

13. The PDP of claim 12, wherein the plurality of cells form a delta structure.

14. The PDP of claim 12, wherein a width of the main discharge space is larger than a width of the auxiliary discharge space.

15. The PDP of claim 12, wherein the main discharge spaces are in two rows and the auxiliary discharge spaces are in one row between the two rows of the main discharge spaces.

16. The PDP of claim 15, wherein one of the two rows of the main discharge spaces comprises upper main discharge spaces and the other of the two rows of the main discharge spaces comprises lower main discharge spaces, and wherein the grooves are respectively alternately formed in the second barrier ribs in a one-to-one correspondence with the upper and lower main discharge spaces so that one of the auxiliary discharge spaces is connected with one of the upper or lower main discharge spaces.

17. The PDP of claim 12, wherein the second barrier ribs face the scan electrode with a discharge gap therebetween.

18. The PDP of claim 12, wherein at least a portion of the second barrier ribs has a height smaller than a height of the first barrier ribs.

19. The PDP of claim 12, wherein the second barrier ribs are closer to the scan electrode than to the sustain electrode.

20. The PDP of claim 12, wherein the phosphor layers are not located in the auxiliary discharge spaces.

21. The PDP of claim 12, wherein the two row sustain electrodes generate a display discharge together with the one row scan electrode.

22. The PDP of claim 12, wherein the scan electrode and the sustain electrode comprise a pair of sustain electrodes and a scan electrode between the sustain electrodes.

23. A plasma display panel (PDP) comprising:
a first substrate;
a second substrate facing the first substrate;
a plurality of barrier ribs between the first substrate and the second substrate, the plurality of barrier ribs defining a plurality of cells;
a scan electrode and a sustain electrode configured to generate a display discharge in the cells;
address electrodes configured to generate an address discharge together with the scan electrode, the address electrodes extending in a direction perpendicular to an extending direction of the scan electrode; and
phosphor layers located in the main discharge spaces,
wherein the barrier ribs comprise:
first barrier ribs defining a plurality of first main discharge cells in a first row and a plurality of second main discharge cells in a second row, each of the first main discharge cells being offset from each of the second main discharge cells in a column direction, and
second barrier ribs defining a plurality of auxiliary discharge cells in a third row between the first row and the second row,
wherein grooves are formed in the first barrier ribs, each of the grooves located between one of the auxiliary discharge cells and a corresponding one of the first main discharge cells or a corresponding one of the second main discharge cells, in an alternating arrangement along the third row.

24. The PDP of claim 23, wherein the plurality of cells form a delta structure.

25. The PDP of claim 24, wherein the delta structure comprises sub-pixels arranged in a triangular shape and constituting one pixel.
